(19) United States
(12) Patent Application Publication
(10) Pub. No.: US 2026/0019156 A1
(43) Pub. Date: Jan. 15, 2026

(54) COMMUNICATION METHOD, APPARATUS, AND SYSTEM, AND TRAIN

(71) Applicant: CRRC QINGDAO SIFANG CO., LTD., Qingdao, Shandong (CN)

(72) Inventors: Lei XU, Qingdao, Shandong (CN); Guodong MA, Qingdao, Shandong (CN); Ying NIE, Qingdao, Shandong (CN); Yulong CUI, Qingdao, Shandong (CN); Yanhong SHI, Qingdao, Shandong (CN)

(73) Assignee: CRRC QINGDAO SIFANG CO., LTD., Qingdao, Shandong (CN)

(21) Appl. No.: 18/994,645

(22) PCT Filed: Sep. 27, 2023
(86) PCT No.: PCT/CN2023/121981

§ 371 Date: Jan. 15, 2025

(30) Foreign Application Priority Data
Nov. 8, 2022 (CN) 202211391359.7

(51) Int. Cl. H04B 10/2587; H04B 10/275

(52) U.S. Cl. CPC H04B 10/2587; H04B 10/275

(57) ABSTRACT

A communication method, which relates to the field of optical fiber communications, is applied to a processor in any carriage of a train. The processor is connected to an optical fiber ring network, and the processor performs communication data interaction with a train communication device in a carriage, and then performs communication data interaction in an optical signal form with the optical fiber ring network, so as to implement communication between the train communication devices in different carriages.

The present disclosure claims priority to Chinese Patent Application No. 202211391359.7, titled “COMMUNICATION METHOD, APPARATUS, AND SYSTEM, AND TRAIN”, filed on Nov. 8, 2022 with the Chinese Patent Office, which is incorporated herein by reference in its entirety.

### FIELD

The present disclosure relates to the field of train communication, and in particular to a communication method, a communication device, a communication system, and a train.

### BACKGROUND

A train is arranged with train communication devices, such as a multimedia system, a control system, and a monitoring system. With the increase of functions on the train, the train communication devices require a large network bandwidth, resulting in the communication network on the train being unable to ensure smooth communication of these train communication devices. In order to ensure smooth communication of the train communication devices, a separate and non-interfering communication network is usually established for each type of the train communication devices according to the conventional technology, so that communication data of different systems is transmitted through corresponding communication networks, avoiding excessive network bandwidth of a single communication network and ensuring smooth communication of the train communication devices. However, for establishing multiple communication networks, it is required to arrange a large number of cables, resulting in a complex wiring environment inside the train. Moreover, the total weight of the train arranged with the large number of cables is significantly increased, not conducive to weight reduction of the train. Furthermore, for a train communication device performing long-distance communication inside the train, the communication data is prone to be lost and affected by electromagnetic interference, resulting in poor communication quality of the train communication device.

### SUMMARY

According to the present disclosure, a communication method, a communication device, a communication system, and a train are provided to ensure communication data is less prone to be lost and affected by electromagnetic interference, thereby improving the communication quality of train communication devices. Further, According to the present disclosure, it is unnecessary to establish multiple communication networks, reducing the complexity of the wiring environment in the train and reducing the total weight of the train.

To solve the above technical problems, a communication method is provided according to the represent disclosure. The communication method is applied to a processor in a carriage of a train. The processor is connected to an optical fiber ring network. The communication method includes: after obtaining a first light beam in the optical fiber ring network, obtaining all carrier optical signals containing communication data in the first light beam; determining a carrier optical signal required by a train communication device in the carriage where the processor is located; transmitting the carrier optical signal required by the train communication device to the train communication device, where the train communication device generates a feedback optical signal based on the carrier optical signal; and synthesizing the feedback optical signal and all carrier optical signals not required by the train communication device to a second light beam, and transmitting the second light beam to the optical fiber ring network.

Preferably, the determining a carrier optical signal required by a train communication device in the carriage where the processor is located and transmitting the carrier optical signal required by the train communication device to the train communication device includes: determining a first wavelength of each of the carrier optical signals; determining a second wavelength of the carrier optical signal required by the train communication device; and transmitting a carrier optical signal, having a first wavelength same as the second wavelength, among the carrier optical signals to the train communication device.

Preferably, the obtaining all carrier optical signals containing communication data in the first light beam includes: decomposing the first light beam into the carrier optical signals based on a corresponding relationship between predetermined wavelengths and communication data.

Preferably, the decomposing the first light beam into the carrier optical signals includes: decomposing the first light beam into the carrier optical signals by performing wavelength division de-multiplexing. The synthesizing the feedback optical signal and all carrier optical signals not required by the train communication device to a second light beam includes: synthesizing the feedback optical signal and all the carrier optical signals not required by the train communication device to the second light beam by performing wavelength division multiplexing.

Preferably, in a case that optical fibers in the optical fiber ring network are multi-core optical fibers, the synthesizing the feedback optical signal and all carrier optical signals not required by the train communication device to a second light beam and transmitting the second light beam to the optical fiber ring network includes: determining a first identifier corresponding to each of the optical fibers in the optical fiber ring network; determining a second identifier corresponding to the feedback optical signal and third identifiers corresponding to the carrier optical signals not required by the train communication device; synthesizing carrier optical signals, each of which has a third identifier same as to the second identifier, among the carrier optical signals and the feedback optical signal to the second light beam; and transmitting the second light beam to the optical fiber ring network through an optical fiber having a first identifier same as the second identifier.

Preferably, the carriage further includes a first optical fiber interface and a second optical fiber interface. The first optical fiber interface is connected to a second optical fiber interface of a carriage adjacent to the carriage through the optical fiber ring network, and the second optical fiber interface is connected to a first optical fiber interface of another carriage adjacent to the carriage through the optical fiber ring network. Before obtaining all the carrier optical signals containing the communication data in the first light beam, the communication method further includes: configuring the second optical fiber interface of the carriage to operate in a virtual disconnection mode. Then, the obtaining all the carrier optical signals containing the communication data in the first light beam is performed.

Preferably, the transmitting the second light beam to the optical fiber ring network includes: determining a target carriage that requires receiving the feedback optical signal; and transmitting the second light beam to the optical fiber ring network via the first optical fiber interface. After transmitting the second light beam to the optical fiber ring network via the first optical fiber interface, the communication method further includes: determining whether the target carriage successfully obtains the second light beam; and configuring, in a case that the target carriage does not successfully obtain the second light beam, the second optical fiber interface of the carriage to operate in a connection mode to transmit the second light beam to the optical fiber ring network via the second optical fiber interface.

A communication device is further provided according to the present disclosure. The communication device includes: a memory and a processor. The memory stores a computer program. The processor is configured to, when executing the computer program, perform the communication method described above.

A communication system is further provided according to the present disclosure. The communication system includes the communication device described above. The communication system further includes: optical fibers, an optical transceiver, and a signal interaction module. The optical fibers are configured to form an optical fiber ring network. The optical transceiver is configured to obtain a first light beam in the optical fiber ring network through the optical fibers and transmit the first light beam to the communication device, and transmit a second light beam emitted by the communication device to the optical fiber ring network through the optical fibers. The signal interaction module is configured to transmit a carrier optical signal transmitted by the communication device to a train communication device of a train, and transmit communication data generated by the train communication device based on the carrier optical signal to the communication device.

Preferably, the communication device further includes a photoelectric conversion module. The photoelectric conversion module is arranged between the communication device and the signal interaction module. The photoelectric conversion module is configured to: convert a carrier optical signal in an optical signal form transmitted by the communication device to a carrier optical signal in an electrical signal form and transmit the carrier optical signal in the electrical signal form to the signal interaction module, and convert communication data in the electrical signal form transmitted by the signal interaction module to a feedback optical signal in the optical signal form and transmit the feedback optical signal in the optical signal form to the communication device.

Preferably, the photoelectric conversion module includes: a photoelectric converter and a differential conversion module. The photoelectric converter is configured to: convert the carrier optical signal in the optical signal form transmitted by the communication device to a first differential signal in the electrical signal form, and convert a second differential signal in the electrical signal form transmitted by the differential conversion module to the feedback optical signal in the optical signal form and transmit the feedback optical signal in the optical signal form to the communication device. The differential conversion module is configured to: convert the first differential signal in the electrical signal form to a carrier optical signal in the electrical signal form and transmit the carrier optical signal in the electrical signal form to the signal interaction module, and convert the communication data in the electrical signal form transmitted by the signal interaction module to a second differential signal in the electrical signal form.

A train is further provided according to the present disclosure. The train includes: multiple carriages, and the communication system described above. The communication system is arranged in each of the carriages.

According to the present disclosure, a communication method, a communication device, a communication system, and a train are provided, relating to the field of optical fiber communication. The communication method is applied to a processor in a carriage of a train. The processor is connected to an optical fiber ring network. After obtaining a first light beam in the optical fiber ring network, all carrier optical signals containing communication data in the first light beam are obtained. A carrier optical signal required by a train communication device in the carriage where the processor is located is determined among the carrier optical signals. The carrier optical signal required by the train communication device is transmitted to the train communication device, so that the train communication device generates a feedback optical signal based on the carrier optical signal. Then, the feedback optical signal and all carrier optical signals not required by the train communication device are synthesized to a second light beam, and the second light beam is transmitted to the optical fiber ring network. Data transmission is performed by using optical fibers instead of cables, so that the communication data is less prone to be lost and be affected by electromagnetic interference, improving the communication quality of train communication devices. Moreover, communication data of multiple train communication devices is converted to optical signals and then are synthesized to a beam of light for transmission, and only one optical fiber ring network, rather than multiple communication networks, is established to perform simultaneous data transmission of multiple train communication devices, thereby reducing the complexity of the wiring environment in the train and reducing the total weight of the train.

### BRIEF DESCRIPTION OF THE DRAWINGS

In order to more clearly describe the technical solutions in the embodiments of the present disclosure, drawings to be used in the conventional technology or the embodiments of the present disclosure are briefly introduced hereinafter. It is apparent that the drawings described below show merely some embodiments of the present disclosure, and those skilled in the art can obtain other drawings based on the provided drawings without any creative effort.

FIG. 1 is a flowchart of a communication method according to the present disclosure;

FIG. 2 is a schematic structural diagram of an optical fiber ring network according to the present disclosure;

FIG. 3 is a schematic diagram of a single-core optical fiber according to the present disclosure;

FIG. 4 is a schematic diagram of a multi-core optical fiber according to the present disclosure;

FIG. 5 is a schematic structural diagram of a communication device according to the present disclosure;

FIG. 6 is a schematic structural diagram of a communication system according to the present disclosure; and

FIG. 7 is a schematic structural diagram of a differential conversion module according to the present disclosure.

### DETAILED DESCRIPTION

According to the present disclosure, a communication method, a communication device, a communication system, and a train are provided. The communication data is less prone to be lost and be affected by electromagnetic interference, improving the communication quality of train communication devices. Moreover, it is unnecessary to establish multiple communication networks, reducing the complexity of the wiring environment in the train and reducing the total weight of the train.

In order to make the purpose, technical solutions and advantages of the embodiments of the present disclosure clearer, the technical solutions in the embodiments of the present disclosure are to be clearly and completely described below in conjunction with the drawings in the embodiments of the present disclosure. Apparently, the embodiments described below are only some embodiments of the present disclosure, rather than all the embodiments. All other embodiments obtained by those skilled in the art based on the embodiments in the present disclosure without any creative work fall within the protection scope of the present disclosure.

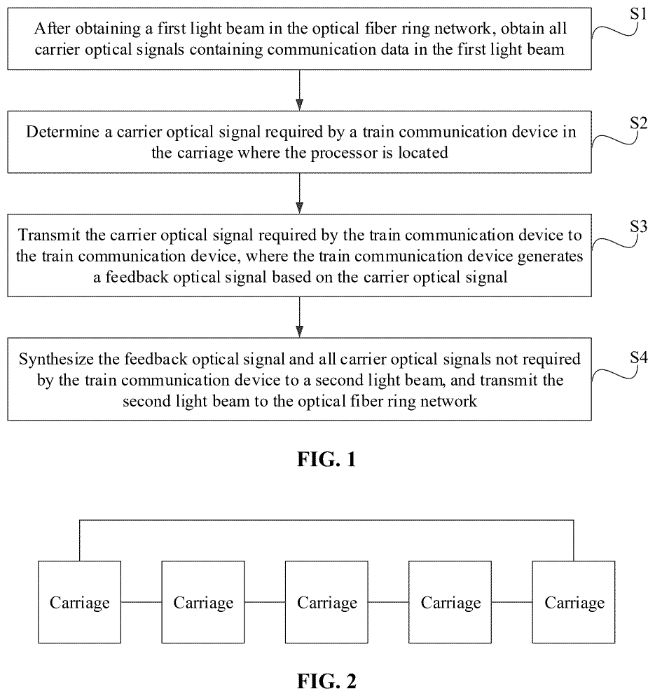

Referring to FIG. 1, FIG. 1 is a flowchart of a communication method according to the present disclosure. The communication method is applied to a processor in a carriage of a train. The processor is connected to an optical fiber ring network. The communication method includes the following steps S1 to S4.

In step S1, after obtaining a first light beam in the optical fiber ring network, all carrier optical signals containing communication data in the first light beam are obtained.

In step S2, a carrier optical signal required by a train communication device in the carriage where the processor is located is determined.

In step S3, the carrier optical signal required by the train communication device is transmitted to the train communication device, so that the train communication device generates a feedback optical signal based on the carrier optical signal.

In step S4, the feedback optical signal and all carrier optical signals not required by the train communication device are synthesized to a second light beam, and the second light beam is transmitted to the optical fiber ring network.

The conventional train system includes train communication devices, such as the multimedia system, the control system, and the monitoring system. Due to the limited network bandwidth of trains, it is difficult for a single cable to support data transmission of all the train communication devices. Therefore, in the conventional technology, each type of train communication devices is usually independently networked as an independent communication network system. For example, for the conventional trains, cables supporting 100 Mbps bandwidth transmission and 1000 Mbps bandwidth transmission are usually used for networking. However, just the monitoring system requires performing data transmission using an Ethernet with a 1000 Mbps transmission rate, that is, using cables with an approximate 1000 Mbps bandwidth. Thus, a single cable cannot support the data transmission of all the train communication devices. For each kind of train communication devices on the train, it is required to establish an independent communication network, and different communication networks do not interfere with each other. In this way, although it is ensured that all the train communication devices can perform data transmission normally, each type of train communication devices is independently networked and it is required to arrange a set of cables for each type of train communication devices. Thus, multiple sets of cables are arranged in the train, and each of the sets of cables connects the cables of all the carriages of the train, resulting in a complex wiring environment in the train. Moreover, a large number of cables significantly increase the total weight of the train. In addition, due to that cables with higher transmission rates or bandwidths have poorer anti-interference capabilities and communication data with longer transmission distances in cables is subject to greater loss and interference, the communication qualities of the train communication devices are poor in the long-distance data transmission in the train.

To solve the above technical problems, optical fibers are used instead of cables for transmission in the present disclosure. A bandwidth of a single optical fiber may reach tens of THz, which is significantly higher than a bandwidth of a cable that is only 100M or 1000M. A single optical fiber may support data transmission for all networks on the train. In addition, the optical fiber has a low signal loss. Taking an 800 MHz signal as an example, the signal loss per kilometer for a cable transmitting the 800 MHz signal is greater than 40 dB, and the signal loss per kilometer for an optical fiber transmitting the 800 MHz signal is only 0.2 dB. Further, the transmission via the optical fiber is not affected by electromagnetic interference. Therefore, instead of the conventional each network performing data transmission using a separate set of cables, all the networks share a single optical fiber to perform data transmission, significantly reducing the complexity of wiring and reducing the total weight of the train, and further improving the quality of data transmission.

Due to that the processors in each of carriages are connected in series through optical fibers to form a communication network, in a case that a processor is disconnected, the communication line between two processors adjacent to the processor is disconnected, thus the two processors cannot communicate with each other. Therefore, based on the series connection, a fiber output terminal of the last carriage is connected to a fiber input terminal of the first carriage to form an optical fiber ring network. Referring to FIG. 2, FIG. 2 is a schematic structural diagram of an optical fiber ring network according to the present disclosure. In practical applications, a default transmission direction of a light beam may be predetermined based on the arrangement order of the carriages. In a processor of a current carriage transmitting communication data to a processor of another carriage, the processor of the current carriage, on detecting that a processor of a carriage between the two carriages is disconnected, may transmit communication data to the processor of the another carriage in an opposite direction of the default transmission direction, thereby performing normal communication between the processors of the two carriages even in a case that a processor is disconnected. For example, it is assumed there are four carriages A, B, C and D, the optical fiber ring network of the four carriages is A-B-C-D-A, and the default transmission direction of the light beam is set as from A to D. In a case that a processor of carriage A requires to transmit communication data to a processor of carriage C, the communication data is to be transmitted along a path of A-B-C by default. On detecting that a processor of carriage B is disconnected, the processor of carriage A may transmit communication data to the processor of carriage C along an opposite direction of the default transmission direction, that is, along a path of A-D-C, so that the processors of carriages A and C may communicate normally in a case that the processor of carriage B is disconnected.

To transmit data of all systems via a single optical fiber, carrier optical signals having different features may be defined in advance for the train communication devices according to the present disclosure. For example, carrier optical signals having different features, such as wavelengths, wave speeds or light intensities, are defined for the train communication devices. In practical applications, data is transmitted through optical fibers, and all different carrier optical signals are synthesized to a beam of light and then is transmitted through a single optical fiber. For a processor of each of carriages, the processor is connected to all train communication devices in the current carriage and is connected to the optical fiber ring network. In a case that a train communication device of another carriage transmits communication data to a train communication device of the current carriage, a carrier optical signal containing the communication data is transmitted in the optical fiber ring network. After receiving a first light beam containing the carrier optical signal, the processor may decompose the first light beam into multiple carrier optical signals containing communication data, and the processor may obtain the carrier optical signal from the multiple carrier optical signals, that is, may determine the carrier optical signal required by the train communication device. Then, the carrier optical signal is transmitted to the train communication device. Thus, this type of train communication devices communicates with each other between different carriages. In a case that a train communication device requires to transmit communication data and perform communication feedback, the train communication device may generate the communication data or feedback data and converts the communication data and the feedback data to a carrier optical signal. The processor receives the carrier optical signal, and then synthesizes the carrier optical signal and the carrier optical signals that have been obtained by decomposing and are not required by the train communication device in the carriage to another beam of light, that is, a second light beam. Then, the processor transmits the second light beam to the optical fiber ring network, so that the carrier optical signal may be transmitted to a carriage requiring performing communication or feedback.

In summary, after obtaining a first light beam in the optical fiber ring network, all carrier optical signals containing communication data in the first light beam are obtained. A carrier optical signal required by a train communication device in the carriage where the processor is located is determined among the carrier optical signals. The carrier optical signal required by the train communication device is transmitted to the train communication device, so that the train communication device generates a feedback optical signal based on the carrier optical signal. Then, the feedback optical signal and all carrier optical signals not required by the train communication device are synthesized to a second light beam, and the second light beam is transmitted to the optical fiber ring network. Data transmission is performed by using optical fibers instead of cables, so that the communication data is less prone to be lost and be affected by electromagnetic interference, improving the communication quality of train communication devices. Moreover, communication data of multiple train communication devices is converted to optical signals and then are synthesized to a beam of light for transmission, and only one optical fiber ring network, rather than multiple communication networks, is established to perform simultaneous data transmission of multiple train communication devices, thereby reducing the complexity of the wiring environment in the train and reducing the total weight of the train.

Based on the above embodiments, in a preferred embodiment, the carrier optical signal required by the train communication device in the carriage where the processor is located is determined and the carrier optical signal required by the train communication device is transmitted to the train communication device by: determining a first wavelength of each of the carrier optical signals; determining a second wavelength of the carrier optical signal required by the train communication device; and transmitting a carrier optical signal, having a first wavelength same as the second wavelength, among the carrier optical signals to the train communication device.

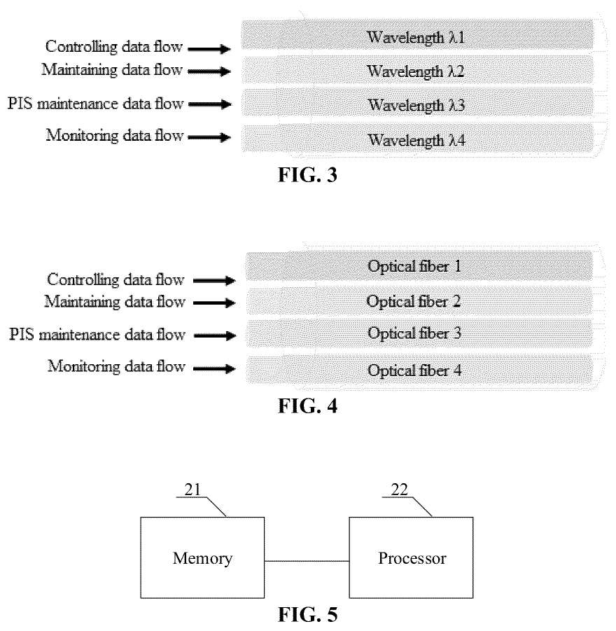

According to the present disclosure, the carrier optical signal required by the train communication device may be determined based on a wavelength of light since the wavelength is an obvious feature of the light and is easy to be measured. Specifically, a light beam transmitted through an optical fiber actually includes multiple carrier light signals, which is equivalent to that a non-zero voltage signal exits in a cable and the voltage signal is actually formed by multiple communication data signals in the electrical form. To determine correspondence between the carrier optical signal and communication data transmitted by a type of train communication device, different optical wavelengths may be predefined for the different train communication devices. That is, each type of train communication device corresponds to a carrier optical signal having a certain wavelength. In transmitting carrier optical signals from multiple train communication devices in an optical fiber, the light beam in the optical fiber is equivalent to a beam of light containing multiple carrier optical signals having different wavelengths. In a case that it is required to determine which carrier optical signals in this beam of light are required by the train communication device, first wavelengths of the carrier optical signals may be detected since it is known that the wavelength corresponding to the train communication device is the second wavelength. Then, a carrier optical signal, having a first wavelength same as the second wavelength of the train communication device, is determined as the carrier optical signal required by the train communication device. Referring to FIG. 3, FIG. 3 is a schematic diagram of a single-core optical fiber according to the present disclosure. A carrier optical signal having a certain wavelength may be defined in advance for each of the train communication devices. A control data stream transmitted by the control system may correspond to a carrier optical signal having a wavelength of λ1, the monitoring system may correspond to a carrier optical signal having a wavelength of λ4, and the like. After obtaining a beam of light, in a case that it is detected that the beam of light contains a carrier optical signal having a wavelength of λ1, it may be determined that the carrier optical signal is a carrier optical signal required by the control system. Therefore, the carrier optical signal required by the train communication device may be simply and accurately determined based on the wavelength of the carrier optical signal.

In a preferred embodiment, all the carrier optical signals containing communication data in the first light beam are obtained by: decomposing the first light beam into the carrier optical signals based on a corresponding relationship between predetermined wavelengths and communication data.

To accurately decompose the first light beam, a light beam may be decomposed based on a corresponding relationship between wavelengths and communication data according to the present disclosure since the light beam is actually containing multiple carrier light signals having different wavelengths. Specifically, based on the corresponding relationship between the predetermined wavelengths and the communication data, it can be seen that the control system corresponds to the carrier optical signal having the wavelength of λ1, the monitoring system corresponds to the carrier optical signal having the wavelength of λ4, and the like. It should be noted that in practical applications, it is difficult to ensure that the carrier optical signals transmitted by the train communication device have a same wavelength. A range may be configured for the wavelengths of each type of train communication device. Therefore, the wavelengths, such as λ1 or λ4, actually refer to a wavelength range, rather than an exact wavelength value. For example, λ1 actually refers to a carrier optical signal in a wavelength range of 1300 nm to 1350 nm, rather than a carrier optical signal having a wavelength of 1300 nm. Therefore, the light beam may be decomposed based on wavelength ranges to obtain carrier optical signals in different wavelength ranges, thereby accurately decomposing the first light beam.

In a preferred embodiment, the first light beam is decomposed into the carrier optical signals by: decomposing the first light beam into the carrier optical signals by performing wavelength division de-multiplexing. The feedback optical signal and all carrier optical signals not required by the train communication device are synthesized to a second light beam by: synthesizing the feedback optical signal and all the carrier optical signals not required by the train communication device to the second light beam by performing wavelength division multiplexing.

To simply decompose and synthesize light beams, a light beam may be decomposed by performing wavelength division de-multiplexing and light beams may be synthesized by performing wavelength division multiplexing according to the present disclosure. The wavelength division multiplexing is a technology according to which multiple carrier optical signals having different wavelengths are synthesized and then are coupled to a same optical fiber for transmission. The wavelength division de-multiplexing is a technology according to which light in an optical fiber is decomposed into carrier optical signals having different wavelengths. Specifically, for the wavelength division multiplexing, a low-loss window of an optical fiber is divided into several channels having different wavelengths based on wavelengths. After receiving carrier optical signals from the train communication devices, the carrier optical signals having different wavelengths are synthesized and then transmitted to an optical fiber for transmission at a beam transmitting terminal by using a wavelength division multiplexer. Similar to wavelength division multiplexing, for the wavelength division de-multiplexing, a light beam is decomposed into carrier optical signals having different wavelengths by using a wavelength division de-multiplexer, and then the carrier optical signals having different wavelengths are transmitted to corresponding train communication devices. In addition, compared with other technologies for decomposing and synthesizing light beams, the wavelength division multiplexing and the wavelength division de-multiplexing are performed using passive devices without requiring additional power supplies, thereby reducing the total energy consumption of the trains. Therefore, light beams can be easily decomposed and synthesized by performing wavelength division multiplexing and wavelength division de-multiplexing.

In a preferred embodiment, in a case that optical fibers in the optical fiber ring network are multi-core optical fibers, the feedback optical signal and all carrier optical signals not required by the train communication device are synthesized to the second light beam and the second light beam is transmitted to the optical fiber ring network by: determining a first identifier corresponding to each of the optical fibers in the optical fiber ring network; determining a second identifier corresponding to the feedback optical signal and third identifiers corresponding to the carrier optical signals not required by the train communication device; synthesizing carrier optical signals, each of which has a third identifier same as to the second identifier, among the carrier optical signals and the feedback optical signal to the second light beam; and transmitting the second light beam to the optical fiber ring network through an optical fiber having a first identifier same as the second identifier.

With the development of the times, various train communication devices on trains may require a large network bandwidth and a single optical fiber may not be able to simultaneously transmit communication data of all the train communication devices. To improve the bandwidth of the optical fiber ring network, multi-core optical fibers, instead of single-core optical fibers, may be adopted in the optical fiber ring networks according to the present disclosure. Each of cores of a multi-core optical fiber may serve as a transmission path for communication data. Each of the cores of the multi-core optical fiber only transmits communication data of one type of train communication device. Referring to FIG. 4, FIG. 4 is a schematic diagram of a multi-cores optical fiber according to the present disclosure. The multi-core optical fiber includes four cores for transmitting communication data of four types of communication systems. In practical applications, in synthesizing the feedback optical signal and the carrier optical signals to the second light beam, the feedback optical signal of the train communication device and the carrier optical signals of the train communication device may be synthesized to a second light beam only containing the carrier optical signals of the train communication device, and then the second light beam is transmitted to the optical fiber ring network through an optical fiber core corresponding to the train communication device. Although the number of cores of the optical fiber is increased, the optical fiber is equivalent to an optical cable including multiple cores. Compared to the arrangement of multiple sets of communication networks and multiple sets of cables in the conventional technology, the communication method with the multi-core optical fiber according to the present disclosure has the advantages of simple wiring, reducing train weight and improved communication quality. Therefore, with the multi-core optical fibers, communication data of different train communication devices is transmitted with different optical fiber cores, so that the bandwidth of the optical fiber ring network is increased, ensuring smooth communication of train communication devices.

In a preferred embodiment, the carriage further includes a first optical fiber interface and a second optical fiber interface. The first optical fiber interface is connected to a second optical fiber interface of a carriage adjacent to the carriage through the optical fiber ring network, and the second optical fiber interface is connected to a first optical fiber interface of another carriage adjacent to the carriage through the optical fiber ring network. Before obtaining all the carrier optical signals containing the communication data in the first light beam, the communication method further includes: configuring the second optical fiber interface of the carriage to operate in a virtual disconnection mode. Then, all the carrier optical signals containing the communication data in the first light beam are obtained.

To ensure normal transmission of light beams and carrier optical signals, each of processors obtains a first light beam in a optical fiber and transmits a second light beam through the optical fiber according to the present disclosure. Therefore, in actual application scenarios, a large number of optical signals are transmitted through an optical fiber. In addition, due to that the optical fiber ring network is a head-to-tail signal transmission line without a line starting point and a line ending point, in such a circular transmission line, a light beam sent by each of processors is to be repeatedly transmitted through the optical fiber, and each of the processors in the optical fiber ring network repeatedly receives the same carrier optical signal and repeatedly transmits a second light beam to the optical fiber ring network, resulting in serious broadcast storm failures. To avoid broadcast storms and ensure the normal transmission of the carrier optical signals, it is required to actively cut off the optical fiber ring network to avoid the ring structure. Specifically, each of the carriages is arranged with two optical fiber interfaces, and one of the carriages where the processors are arranged may be defined as a main carriage. For example, the driver's cab or the monitoring room may be defined as the main carriage, and one of the optical fiber interfaces of the main carriage is simulated to be in a disconnected mode, that is, the second optical fiber interface of the main carriage is configured to operate in a virtual disconnection mode. For example, a selection switch or an input resistor may be arranged at the second optical fiber interface. The second optical fiber interface may be configured to operate in the virtual disconnection mode by turning on or turning off the selection switch or increasing the resistance of the input resistor, so that the optical fiber ring network is configured to have a linear structure, thereby avoiding repeated transmission of the light beams and the carrier optical signals in the optical fiber ring network and ensuring the normal transmission of the light beams and the carrier optical signals. In addition, to ensure the integrity of the optical fiber ring network, it is only required to configure a second optical fiber interface of one carriage to operate in the virtual disconnection mode to control the optical fiber ring network to have a linear structure, without configuring the second optical fiber interfaces of multiple carriages to operate in the virtual disconnection mode.

In a preferred embodiment, the second light beam is transmitted to the optical fiber ring network by: determining a target carriage that requires receiving the feedback optical signal; and transmitting the second light beam to the optical fiber ring network via the first optical fiber interface. After transmitting the second light beam to the optical fiber ring network via the first optical fiber interface, the communication method further includes: determining whether the target carriage successfully obtains the second light beam; and configuring, in a case that the target carriage does not successfully obtain the second light beam, the second optical fiber interface of the carriage to operate in a connection mode to transmit the second light beam to the optical fiber ring network via the second optical fiber interface.

To ensure normal transmission of light beams and carrier optical signals, in the present disclosure, since the second optical fiber interface of the main carriage is virtually disconnected, the optical fiber ring network operates in a linear structure, and processors of two carriages can only communicate with each other in one direction. During the communication of the two processors, in a case that a processor of a carriage between two carriages where the two processors are respectively arranged is disconnected, the optical fiber ring network is disconnected at two positions to have a two-line structure, and the two processors cannot communicate with each other. That is, in a case that an optical fiber interface has been virtually disconnected and a real line disconnection failure occurs, the two processors cannot communicate with each other. Therefore, after a real line disconnection failure occurs, the second optical fiber interface of the main carriage may be restored to a normal connection mode. For example, the selection switch at the second optical fiber interface may be turned on or the resistance of the input resistor may be reduced to control the second optical fiber interface to operate from the virtual disconnection mode to the normal connection mode. Thus, the optical fiber ring network is restored from two-line structure to one-line structure. Then, communications between two processors of any two carriages respectively on two sides of the carriage where the disconnected processor is located can be restored after changing the transmission direction of the processors, thereby ensuring the normal transmission of light beams and carrier optical signals.

Referring to FIG. 5, FIG. 5 is a schematic structural diagram of a communication device according to the present disclosure. The communication device includes: a memory 21 and a processor 22. The memory 21 stores a computer program. The processor 22 is configured to, when executing the computer program, perform the communication method described above.

For detailed descriptions of the communication device according to the present disclosure, one may refer to the above embodiments of the communication method, which are not repeated herein.

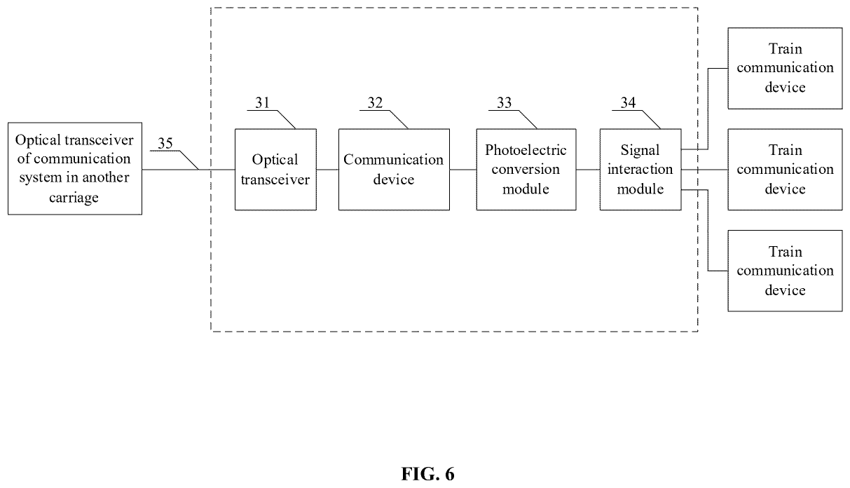

Referring to FIG. 6, FIG. 6 is a schematic structural diagram of a communication system according to the present disclosure. The communication system includes: the communication device 32, optical fibers 35, an optical transceiver 31, and a signal interaction module 34.

The optical fibers 35 are configured to form an optical fiber ring network.

The optical transceiver 31 is configured to obtain a first light beam in the optical fiber ring network through the optical fibers 35 and transmit the first light beam to the communication device 32, and transmit a second light beam emitted by the communication device 32 to the optical fiber ring network through the optical fibers 35.

The signal interaction module 34 is configured to transmit a carrier optical signal transmitted by the communication device 32 to a train communication device of a train, and transmit communication data generated by the train communication device based on the carrier optical signal to the communication device 32.

For detailed descriptions of the communication system according to the present disclosure, one may refer to the above embodiments of the communication method, which are not repeated herein.

To ensure normal communication of train communication devices, in the present disclosure, a processor performs data interaction with train communication devices through the signal interaction module 34, that is, interaction of carrier optical signals and feedback optical signals. The processor obtains a light beam in the optical fiber ring network through the optical transceiver 31. Multiple optical transceivers 31 may be arranged, and one of the multiple optical transceivers 31 is defined as a main optical transceiver 31. In normal operation scenarios, only the main optical transceiver 31, without using the other idle optical transceivers 31, is used for the communication device 32 obtaining the first light beam from the optical fiber ring network and transmitting the second light beam to the optical fiber ring network. In a case that the communication device 32 cannot perform data interaction with the optical fiber ring network through the main optical transceiver 31 due to line disconnection or failure or other reasons of the main optical transceiver 31, one of the other idle optical transceivers 31 may be defined as a new main optical transceiver 31. Furthermore, in forming the optical fiber ring network, multiple optical transceivers 31 may be arranged at both ends of each of the carriages for communication between the carriage and carriages adjacent to the carriage. Therefore, multiple optical transceivers 31 may be arranged, and a backup optical transceiver 31 may be defined as a new main optical transceiver 31 in a case than the original main optical transceiver 31 fails, thereby ensuring normal communication of the train communication devices.

Based on the above embodiments, in a preferred embodiment, the communication system further includes: a photoelectric conversion module 33. The photoelectric conversion module 33 is arranged between the communication device 32 and the signal interaction module 34. The photoelectric conversion module 33 is configured to: convert a carrier optical signal in an optical signal form transmitted by the communication device 32 to a carrier optical signal in an electrical signal form and transmit the carrier optical signal in the electrical signal form to the signal interaction module 34, and convert communication data in the electrical signal form transmitted by the signal interaction module 34 to a feedback optical signal in the optical signal form and transmit the feedback optical signal in the optical signal form to the communication device 32.

To enable the train communication device to normally receive carrier optical signals, in the present disclosure, it is considered that due to the different models and styles of the train communication devices adopted in practical applications, some train communication devices cannot perform photoelectric conversion and therefore cannot obtain carrier optical signals transmitted by the communication device 32. Therefore, a photoelectric conversion module 33 may be arranged between the communication device 32 and the signal interaction module 34, and the signal interaction module 34 changes from transmitting optical signals to transmitting electrical signals. In the communication device 32 transmitting a carrier optical signal to a train communication device, the photoelectric conversion module 33 converts the carrier optical signal to an electrical signal and transmits the electrical signal to the signal interaction module 34, and then the signal interaction module 34 transmits the electrical signal to the train communication device. Similarly, after a train communication device obtains a carrier optical signal in an electrical signal form and generates a feedback signal, the signal interaction module 34 receives the feedback signal and transmits the feedback signal to the photoelectric conversion module 33, and the photoelectric conversion module 33 convert the feedback signal to a feedback optical signal in an optical signal form and then transmits the feedback optical signal in the optical signal form to the communication device 32. Therefore, with the photoelectric conversion module, the train communication devices that cannot perform photoelectric conversion can receive carrier optical signals normally.

In a preferred embodiment, the photoelectric conversion module 33 includes: a photoelectric converter and a differential conversion module.

The photoelectric converter is configured to: convert the carrier optical signal in the optical signal form transmitted by the communication device 32 to a first differential signal in the electrical signal form, and convert a second differential signal in the electrical signal form transmitted by the differential conversion module to the feedback optical signal in the optical signal form and transmit the feedback optical signal in the optical signal form to the communication device 32.

The differential conversion module is configured to: convert the first differential signal in the electrical signal form to a carrier optical signal in the electrical signal form and transmit the carrier optical signal in the electrical signal form to the signal interaction module 34, and convert the communication data in the electrical signal form transmitted by the signal interaction module 34 to a second differential signal in the electrical signal form.

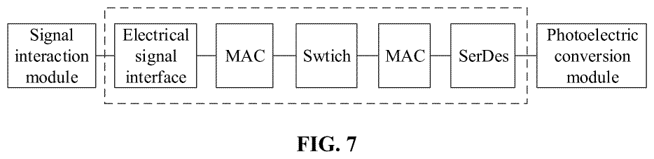

To ensure performing photoelectric conversion normally, in the present disclosure, it is considered that some photoelectric converters can only convert differential signals and the converted signals in the electrical signal form obtained by the photoelectric converters are usually differential signals. To enable all photoelectric converters to perform photoelectric conversion on feedback signals transmitted by the train communication devices, it is required to arrange a photoelectric converter and a differential conversion module. The photoelectric converter performs conversion between optical signals and electrical signals. That is, the photoelectric converter converts a carrier optical signal in an optical signal form to a carrier optical signal in an electrical signal form, or converts a feedback signal in an electrical signal form to a feedback signal in an optical signal form. The differential conversion module further performs conversion on the carrier optical signal or the feedback signal. Specifically, after the photoelectric conversion module 33 converts a carrier optical signal in the optical signal form to a carrier optical signal in the electrical signal form, the outputted signal in the electrical signal form may be a high-speed differential signal. Therefore, it is required for the differential conversion module to convert the outputted signal to an ordinary low-speed carrier optical signal in the electrical signal form and then transmit the carrier optical signal to a train communication device. Similarly, after a train communication device transmits a feedback signal in an electrical signal form, the differential conversion module converts the feedback signal in the electrical signal form to a differential signal and then transmits the differential signal to the photoelectric converter for photoelectric conversion. In performing differential conversion, the differential conversion module performs conversion between a multi-channel feedback signal and a few-channel high-speed differential signal. Referring to FIG. 7, FIG. 7 is a schematic structural diagram of a differential conversion module according to the present disclosure. In converting an electrical signal generated by a train communication device to an optical signal, an electrical signal obtained by the signal interaction module from the train communication device is obtained through an electrical signal interface, then a multiple access channel (MAC) module determines the number of channels of the electrical signal, then a switch module decomposes the electrical signal into multiple single-channel signals and then synthesizes the multiple single-channel signals to a few-channel differential signal, and then another MAC module outputs a differential signal, and then the differential signal is transmitted to the photoelectric conversion module through a SerDes interface. For example, one four-channel feedback signal is decomposed into four single-channel signals, and then the four single-channel signals are synthesized to one two-channel differential signal, thereby performing differential conversion. Therefore, with the differential conversion module, the photoelectric conversion can be performed normally.

A train is further provided according to the present disclosure. The train includes multiple carriages and the communication system. The communication system is arranged in each of the carriages.

For detailed descriptions of the train according to the present disclosure, one may refer to the above embodiments of the communication method, which are not repeated herein.

The embodiments in the present disclosure are described in a progressive manner, and each of the embodiment focuses on the differences from other embodiments. The same and similar parts between the embodiments can be referred to each other. Since the device disclosed in embodiments is corresponding to the method disclosed herein, the description about the device is relatively simple, and the relevant parts can be referred to the description of the method.

It should also be noted that in the present disclosure, relational terms such as first and second are only used to distinguish one entity or operation from another entity or operation. It is not necessarily required or implied that any such actual relationship or order exists among the entities or the operations. Moreover, the terms “include”, “comprise” or any other variants thereof are intended to cover non-exclusive inclusion, so that a process, a method, an article or a device including a series of elements includes not only those elements, but also other elements not explicitly listed, or also includes elements inherent to such a process, a method, an article or a device. In the absence of further restrictions, an element defined by the statement “including a . . . ” does not exclude the existence of other identical elements in the process.

1. A communication method, applied to a processor in a carriage of a train, wherein the processor is connected to an optical fiber ring network, and the communication method comprises:
after obtaining a first light beam in the optical fiber ring network, obtaining all carrier optical signals containing communication data in the first light beam;
determining a carrier optical signal required by a train communication device in the carriage where the processor is located;
transmitting the carrier optical signal required by the train communication device to the train communication device, wherein the train communication device generates a feedback optical signal based on the carrier optical signal; and
synthesizing the feedback optical signal and all carrier optical signals not required by the train communication device to a second light beam, and transmitting the second light beam to the optical fiber ring network.

2. The communication method according to claim 1, wherein the determining a carrier optical signal required by a train communication device in the carriage where the processor is located and transmitting the carrier optical signal required by the train communication device to the train communication device comprises:
determining a first wavelength of each of the carrier optical signals;
determining a second wavelength of the carrier optical signal required by the train communication device; and
transmitting a carrier optical signal, having a first wavelength same as the second wavelength, among the carrier optical signals to the train communication device.

3. The communication method according to claim 2, wherein the obtaining all carrier optical signals containing communication data in the first light beam comprises:
decomposing the first light beam into the carrier optical signals based on a corresponding relationship between predetermined wavelengths and communication data.

4. The communication method according to claim 3, wherein
the decomposing the first light beam into the carrier optical signals comprises:
decomposing the first light beam into the carrier optical signals by performing wavelength division de-multiplexing; and
the synthesizing the feedback optical signal and all carrier optical signals not required by the train communication device to a second light beam comprises:
synthesizing the feedback optical signal and all the carrier optical signals not required by the train communication device to the second light beam by performing wavelength division multiplexing.

5. The communication method according to claim 1, wherein in a case that optical fibers in the optical fiber ring network are multi-core optical fibers, the synthesizing the feedback optical signal and all carrier optical signals not required by the train communication device to a second light beam and transmitting the second light beam to the optical fiber ring network comprises:
determining a first identifier corresponding to each of the optical fibers in the optical fiber ring network;
determining a second identifier corresponding to the feedback optical signal and third identifiers corresponding to the carrier optical signals not required by the train communication device;
synthesizing carrier optical signals, each of which has a third identifier same as to the second identifier, among the carrier optical signals and the feedback optical signal to the second light beam; and
transmitting the second light beam to the optical fiber ring network through an optical fiber having a first identifier same as the second identifier.

6. The communication method according to claim 1, wherein
the carriage further comprises a first optical fiber interface and a second optical fiber interface, the first optical fiber interface is connected to a second optical fiber interface of a carriage adjacent to the carriage through the optical fiber ring network, and the second optical fiber interface is connected to a first optical fiber interface of another carriage adjacent to the carriage through the optical fiber ring network; and
before obtaining all the carrier optical signals containing the communication data in the first light beam, the communication method further comprises:
configuring the second optical fiber interface of the carriage to operate in a virtual disconnection mode, wherein then the obtaining all the carrier optical signals containing the communication data in the first light beam is performed.

7. The communication method according to claim 6, wherein the transmitting the second light beam to the optical fiber ring network comprises:
determining a target carriage that requires receiving the feedback optical signal; and
transmitting the second light beam to the optical fiber ring network via the first optical fiber interface;
wherein after transmitting the second light beam to the optical fiber ring network via the first optical fiber interface, the communication method further comprises:
determining whether the target carriage successfully obtains the second light beam; and
configuring, in a case that the target carriage does not successfully obtain the second light beam, the second optical fiber interface of the carriage to operate in a connection mode to transmit the second light beam to the optical fiber ring network via the second optical fiber interface.

8. A communication device, comprising:
a memory, storing a computer program; and
a processor, configured to, when executing the computer program, perform the communication method according to claim 1.

9. A communication system, comprising the communication device according to claim 8, and further comprising:
optical fibers, configured to form an optical fiber ring network;
an optical transceiver, configured to obtain a first light beam in the optical fiber ring network through the optical fibers and transmit the first light beam to the communication device, and transmit a second light beam emitted by the communication device to the optical fiber ring network through the optical fibers; and
a signal interaction module, configured to transmit a carrier optical signal transmitted by the communication device to a train communication device of a train, and transmit communication data generated by the train communication device based on the carrier optical signal to the communication device.

10. The communication system according to claim 9, further comprising: a photoelectric conversion module, wherein
the photoelectric conversion module is arranged between the communication device and the signal interaction module; and
the photoelectric conversion module is configured to: convert a carrier optical signal in an optical signal form transmitted by the communication device to a carrier optical signal in an electrical signal form and transmit the carrier optical signal in the electrical signal form to the signal interaction module, and convert communication data in the electrical signal form transmitted by the signal interaction module to a feedback optical signal in the optical signal form and transmit the feedback optical signal in the optical signal form to the communication device.

11. The communication device according to claim 9, wherein
the photoelectric conversion module comprises: a photoelectric converter and a differential conversion module;
the photoelectric converter is configured to: convert the carrier optical signal in the optical signal form transmitted by the communication device to a first differential signal in the electrical signal form, and convert a second differential signal in the electrical signal form transmitted by the differential conversion module to the feedback optical signal in the optical signal form and transmit the feedback optical signal in the optical signal form to the communication device; and
the differential conversion module is configured to: convert the first differential signal in the electrical signal form to a carrier optical signal in the electrical signal form and transmit the carrier optical signal in the electrical signal form to the signal interaction module, and convert the communication data in the electrical signal form transmitted by the signal interaction module to a second differential signal in the electrical signal form.

12. A train, comprising:
a plurality of carriages; and
the communication system according to claim 9, wherein
the communication system is arranged in each of the carriages.
